(19) United States
(12) Patent Application Publication
(10) Pub. No.: US 2012/0132173 A1
(43) Pub. Date: May 31, 2012

(54) FUEL CONDITIONING METHOD AND COUPLED COMBUSTION PROCESS FOR INTERNAL COMBUSTION ENGINES

(76) Inventor: Horacio Andres Trucco, Melville, NY (US)

(21) Appl. No.: 12/954,855

(22) Filed: Nov. 27, 2010

(51) Int. Cl. F02B 53/10; F02B 75/22; F02B 25/00

(52) U.S. Cl. 123/205; 123/74 A; 123/55.2

(57) ABSTRACT

A fuel-conditioning-method and coupled-combustion process incorporated into internal combustion engines minimizes exhaust emission and improves fuel economy. Gasification chamber 10 affixed into piston 12 is placed under piston crown 14, transfer port 18 carved into cylinder 20 wall connects into combustion chamber 22, arrow 26 indicates that gasified fuel is transferred from chamber 10 into combustion chamber 22 initiating combustion. When pressure inside combustion chamber 22 is higher than that inside chamber 10 a reverse flow fills chamber 10 with hot combustion gases. During piston 12 downstroke gasification chamber inlet/outlet 34 overpass bottom edge 36 part of transfer port 18, therefore hot combustion gases are shut close inside chamber 10 by cylinder 20 wall. When piston 12 is at BDC fuel injector 24 injects fuel that absorbs heat from entrapped combustion gases vaporizing. During piston upstroke gasification chamber inlet/outlet 34 reaches the bottom edge 36 and the cycle repeats.

### FIELD OF INVENTION

This invention relates to a novel fuel-conditioning-method and coupled-combustion process applicable to piston engines and rotary engines. Liquid fuel is first thermally conditioned inside a gasification chamber comprised inside a piston or inside a rotor and then it is transferred into a combustion chamber when combustion needs to be initiated.

### BACKGROUND-DESCRIPTION OF THE PRIOR ART

Most popular internal combustion engines (ICEs), specifically the Otto cycle or spark ignition (SI) engine, the Diesel cycle or compression ignition (CI) engine and the homogeneous charge compression ignition (HCCI) engine release polluting exhaust requiring a complex and costly after-treatment system in order to comply with government emission standard regulations. The individual combustion processes employed by these engines are responsible for different levels and variety of raw exhaust contaminants.

Decades of ongoing ICE research and development, testing and refinement has yielded impressive improvement in tailpipe exhaust cleaning. However, an alternative combustion processes that would require less costly, simpler and more durable after-treatment devices is needed. Furthermore, feasibility of running an ICE with fuel requiring less refining processes and without additives would be desirable.

Air polluting emissions are caused by incomplete fuel combustion and undesired oxidation reactions intrinsic to the combustion process particular to each ICE. The contaminants affected by emission standards are carbon monoxide (CO), soot or particulate matter (PM), nitrogen oxides (NO_{X}), non-methane organic gases (NMOG) and formaldehyde (HCHO).

In sum, prior art has accomplished enormous progress in reducing ICE tailpipe exhaust pollutants via intricate fuel management, sophisticated combustion chamber designs, special fuel formulation and adequate fuel additives as well as a variety of complex and costly devices for after-treatment of raw exhaust.

The herein disclosed fuel-conditioning-method and coupled-combustion (F-C-M & C-C) process allows to minimize the raw exhaust contaminants from an ICE when compared to actual prior art levels. In addition, application of this invention will yield better fuel economy.

This invention is suitable for incorporation into reciprocating piston engines, free piston engines and rotary engines.

It is believed that the F-C-M & C-C process will provide a cost-effective alternative for air pollution control from ICEs as well as an improved fuel economy.

When this inventor realized the need to create a more efficient combustion process than the processes employed by prior art ICEs, the purposes of this invention were inspired, leading him to the conception and the accomplishment of this invention.

### Advantages of the Invention

This invention provides manufacturers of automobiles, trucks, power plants, marine propulsion, rail locomotives, mines clean energy sources, etceteras with a new, safe, reliable, useful and less costly F-C-M & C-C process for ICEs that permits to substantially abate air pollution contamination when comparing to prior art engines.

The advantages of disclosed F-C-M & C-C process are: (1) a gasification chamber comprised inside a piston allows thermal conditioning (i.e. vaporization and gasification) of the fuel prior to combustion, (2) hot gaseous-fuel ignition delay is negligible, (3) the combustion is controlled by a gaseous mass-diffusion flame, (4) a rich-burn follow by lean-burn mode minimize pollutant formation, (5) fuel is not required to be rated for neither octane or cetane number, (6) improvement of engine fuel economy and (7) permits switching among different liquid fuels.

An important mechanical advantage is that the gasification chamber comprised inside a piston has no valves or moving parts for its closing and opening thus resulting in cost savings, less complexity and more reliability.

Further advantages of the invention will become apparent upon consideration of the following drawings and descriptions.

### BRIEF DESCRIPTION OF THE DRAWING FIGURES

FIG. 1 helps to understand the basic hardware required to implement the F-C-M & C-C process and aids to recognize one of its operational phases by showing two cross-sections of a 2-stroke engine while its piston is at the top dead center (TDC).

FIG. 2 also helps to understand the F-C-M & C-C process by showing two cross-sections of the same 2-stroke engine depicted in FIG. 1 while its piston is at the bottom dead center (BDC).

FIG. 3 depicts as a function of crank angle a typical evolution of the pressure prevailing: (1) inside the combustion chamber of a 2-stroke engine and (2) inside its gasification chamber.

FIG. 4 shows a pair of gasification chambers incorporated into a piston of a 2-stroke engine.

FIG. 5 shows in longitudinal cross-section an uniflow-scavenged 2-stroke engine fitted with the F-C-M & C-C process.

FIG. 6 shows in longitudinal cross-section the application of the F-C-M & C-C process into an opposed piston engine.

FIG. 7 shows in longitudinal cross-section the application of the F-C-M & C-C process into a free piston engine driving an electric generator.

FIG. 8 shows in four cross-sections the application of the F-C-M & C-C process into a Wankel type rotary engine incorporating a single gasification chamber per rotor flank.

FIG. 9 shows the sequential progression of the disclosed F-C-M & C-C process into a Wankel type rotary engine.

FIG. 10 shows in four cross-sections the application of the F-C-M & C-C process into a Wankel type rotary engine incorporating two gasification chambers per rotor-flank.

### REFERENCE NUMERALS IN DRAWINGS

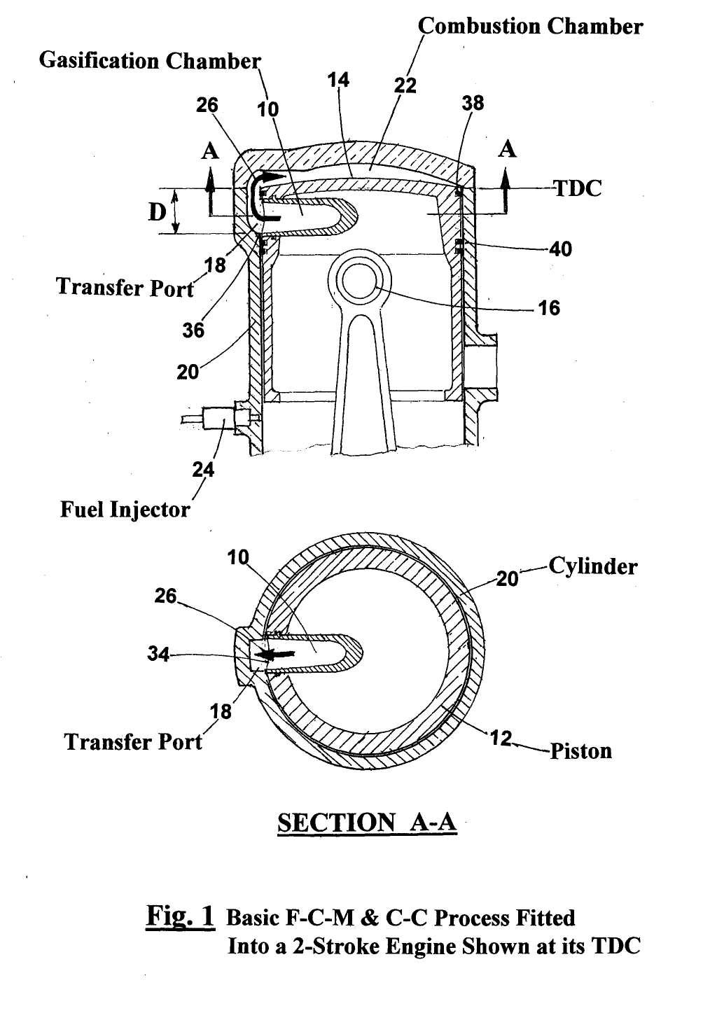

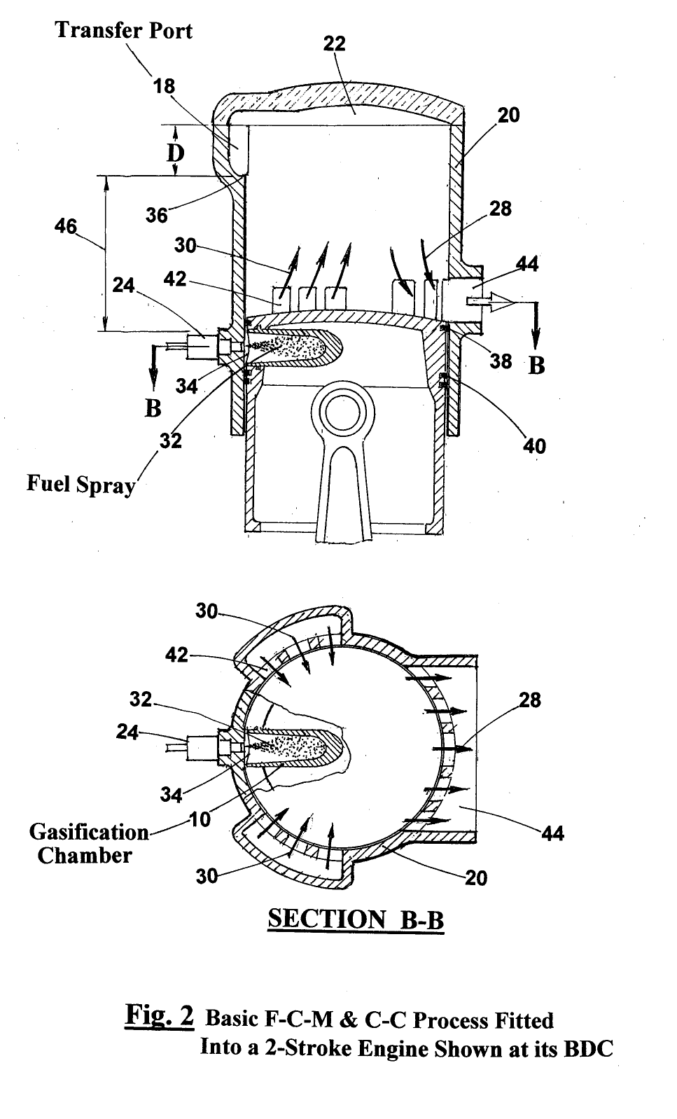

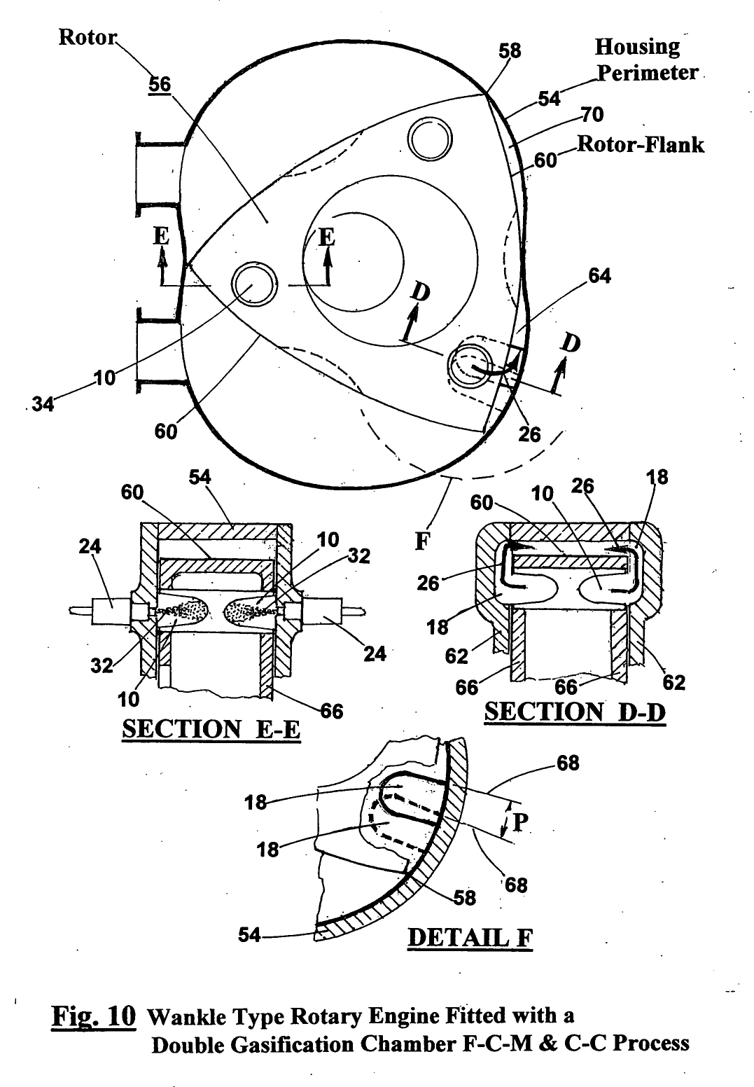

Underlined numerals designate an assembly. The parts cited in the following description are:
10 gasification chamber,
12 piston,
14 piston crown,
16 wrist pin,
18 transfer port,
20 cylinder,
22 combustion chamber,
24 fuel injector,
26 flow direction arrow,
28 exhaust stream,
30 intake stream,
32 fuel spray,
34 gasification chamber inlet,
36 bottom edge (part of transfer port 18),
38 top piston ring,
40 middle piston ring,
42 intake port,
44 exhaust port,
46 sweeping trajectory,
48 central combustion chamber,
50 power module,
52 connecting shaft,
54 housing perimeter,
56 rotor,
58 rotor apex,
60 rotor-flank,
62 housing-side wall,
64 moving combustion chamber,
66 rotor-side wall,
68 leading edge (part of transfer port 18, see Detail C in FIG. 8 see Detail F in FIG. 10),
70 squeezed gas (see FIGS. 8, 9 and 10),
D distance between TDC and bottom edge 36 of transfer port 18 (see FIG. 1 and FIG. 2),
D₁ distance between TDC and bottom edge 36 of transfer port 18 (see FIG. 4 and FIG. 6),
D₂ distance between TDC and bottom edge 36 of transfer port 18 (see FIG. 4 and FIG. 6) and
P peripheral distance between leading edges 68-68 (see Detail F in FIG. 10).

### LIST OF ACRONYMS

The following acronyms are used throughout the specification and the abstract:

BDC (bottom dead center),
BDC_{L} (left piston bottom dead center),
BDC_{R} (right piston bottom dead center),
CI (compression ignition),
CO (carbon monoxide),
F-C-M & C-C (fuel-conditioning-method and coupled-combustion),
HCCI (homogeneous charge compression ignition),
HCHO (formaldehyde),
ICE (internal combustion engine),
NMOG (non-methane organic gases),
NO_{X} (nitrogen oxides),
PM (soot or particulate matter),
SI (spark ignition),
TDC (top dead center),
TDC_{L} (left piston top dead center) and
TDC_{R} (right piston top dead center).

### DESCRIPTION OF INVENTION FUNDAMENTALS

Before proceeding to describe the entire embodiments in the next section, it is important to understand the essential hardware required to implement the disclosed F-C-M & C-C process as well as its operational mode. FIG. 1 and FIG. 2 assist the reader with the task by analyzing a simple embodiment.

FIG. 1 shows components of a 2-stroke engine while its piston is at the TDC position incorporating a F-C-M & C-C process illustrated in accordance with the objectives of this invention comprising: a gasification chamber 10 affixed into piston 12 being placed under piston crown 14 and above wrist pin 16, a transfer port 18 carved into the wall of cylinder 20 connects into combustion chamber 22 and a fuel injector 24 placed on the wall of cylinder 20 bellow piston BDC location. Flow direction arrow 26 indicates that thermally conditioned fuel is being transferred from gasification chamber 10 into combustion chamber 22.

FIG. 2 shows the same 2-stroke engine of FIG. 1 while its piston is at the BDC position, depicting an exhaust stream 28, a intake stream 30 and fuel injector 24 injecting a fuel spray 32 into gasification chamber 10.

In operation, referring to FIG. 1, notice that flow direction arrow 26 indicates that the thermally conditioned fuel prevailing inside gasification chamber 10 is transferred into combustion chamber 22 initiating combustion with the hot-compressed air filling said combustion chamber 22. As piston 12 travels toward the TDC this process is initiated when gasification chamber inlet 34 meets bottom edge 36 pertaining to transfer port 18. During the downward movement of piston 12 as combustion has almost been completed the pressure level prevailing inside combustion chamber 22 is higher than that inside gasification chamber 10 causing a back flow that fills gasification chamber 10 with hot combustion gases.

During the down stroke of piston 12 when gasification chamber inlet 34 over pass the bottom edge 36 pertaining to transfer port 18 the hot combustion gases are shut close inside gasification chamber 10 by the inner wall of cylinder 20. As piston 12 continues traveling toward the BDC hot combustion products remain entrapped inside gasification chamber 10. While approaching the BDC position, see FIG. 2, gasification chamber inlet 34 faces fuel injector 24 that then injects a metered amount of fuel creating a fuel spray 32. Fuel droplets absorb heat from both, the entrapped hot combustion gases and from impingement into the hot wall of gasification chamber 10.

As piston 12 travels towards the TDC there is sufficient residence time for liquid fuel droplets to vaporize and then to reach gaseous phase state. When gasification chamber inlet 34 meets the bottom edge 36 pertaining to port 18, see FIG. 1, the cycle is repeated.

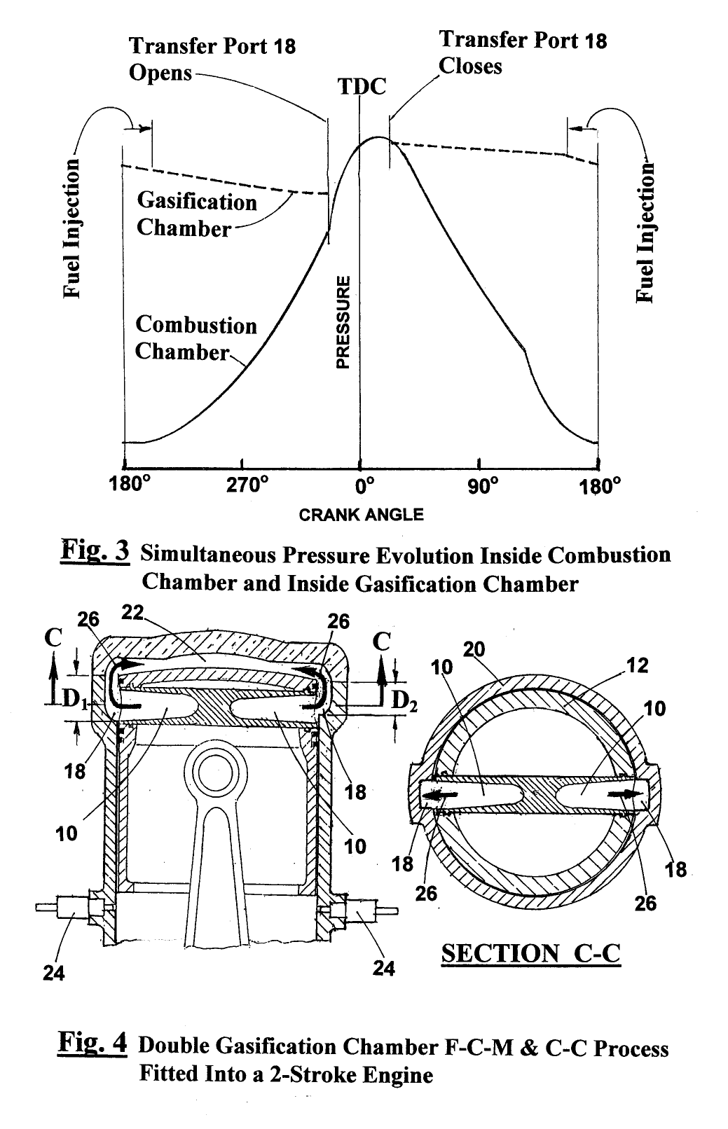

FIG. 3 depicts the simultaneous evolution of the level of pressure prevailing inside combustion camber 22 (see solid line) and gasification chamber 10 (see dashed line) during an engine crankshaft revolution. After transfer port 18 is closed, during the down stroke of piston 12, the pressure and temperature of entrapped combustion products decrease slightly due to heat transferred into gasification chamber 10's wall and cylinder 20's wall. Around the BDC when fuel injector 24 aligns with gasification chamber inlet 34 a window of opportunity for fuel injection develops, see FIG. 2.

Since entrapped combustion products contain insignificant amount of oxygen, when fuel spray 32 is injected no significant combustion occurs inside gasification chamber 10 thus causing a subsequent pressure and temperature decrease as fuel droplets absorb heat to vaporize and to finally reach a gaseous phase state.

The residence time available for fuel droplets vaporization/gasification can be increased by placing fuel injector 24 near the bottom edge 36 pertaining to transfer port 18 and injecting fuel during the piston down stroke. This approach if required, imply the utilization of a more costly fuel injection system that needs to inject at a higher discharge rate and the injector tip is exposed to combustion products, a undesirable hot environ that might cause the overheat of the nozzle tip of fuel injector 24 enough to cause fuel coking thus shortening injector life. The preferred location of fuel injector 24 shown in FIG. 2 allows to utilize a less costly injector that can inject at a lower discharge rate and to work in a relatively cold environ. Notice that this fact is due because around the BDC the speed of piston 12 is at its lowest level and reverses, therefore the time available for fuel to be injected into gasification chamber 10 is maximized.

The average droplets size of a fuel spray injected into prior art ICEs plays a central role in the production of harmful emissions and fuel economy. Smaller droplets are desirable, that requires a more sophisticated and more costly fuel injection system. The F-C-M & C-C process is nearly independent of average droplets size of the injected fuel spray 32 since inside gasification chamber 10 fuel droplets vaporize reaching a gaseous phase. Consequently, a less costly and more rugged fuel injection system is suitable.

Since the combustion products entrapped inside gasification chamber 10 contain insignificant amount of oxygen, NO_{X} formation is negligible during the vaporization/gasification phase.

Referring again to FIG. 3, notice that when transfer port 18 starts to open, say when gasification chamber 10 just connects to combustion chamber 22, the pressure inside gasification chamber 10 is higher than that inside combustion chamber 22 causing gasified fuel to transfer into combustion chamber 22 by passing across transfer port 18 as indicated by flow direction arrow 26, see FIG. 1, thus combustion will initially start inside combustion chamber 22. However, depending on engine specific design, load and speed the reverse may occur and flow direction arrow 26 will switch direction meaning that combustion will start inside gasification chamber 10.

The initial combustion is of the rich-burn mode type, either by (1) hot gasified fuel jetting into a hot air charge contained inside combustion chamber 22, or by (2) hot air jetting into a hot gasified fuel contained inside gasification chamber 10. Since for both cases the flame zone is controlled by the mixing rate between hot gaseous-fuel species and hot air, either inside the combustion chamber 22 or inside gasification chamber 10, there is not a propagating flame front like occurs inside SI or HCCI engines as a result eliminating possibility for the occurrence of detonation. Unlike Diesel engines there is not fuel droplets transferred into combustion chamber 22. Consequently the fuel suitable to operate the F-C-M & C-C process is not required to be rated neither for octane nor for cetane numbers.

This feature is extremely important since allows to exploit cheap petroleum derived fuels, biodiesel, bioalcohol, vegetable oils, biomass liquid fuel, coal-oil-slurry and coal-water-slurry. Inclusion of the vast supply of coal to supply large-low-speed engines is possible when utilizing the disclosed F-C-M & C-C process. Achieving this goal could result on an immense saving on crude petroleum demand.

Because of the initial rich-burn mode just described a temperature level much lower than that corresponding to stoichiometric combustion is achieved and, due to the relative lack of oxygen around the flame zone the formation of NO_{X} is minimized. Additionally, since both air and gaseous-fuel are at relatively high temperature, ignition delay is negligible and chemical reaction rates are very fast compared to prior art ICEs. Consequently it allows for efficient combustion even while the engine is running at relatively high speed.

Furthermore, the intrinsic fast gas-phase initial combustion described above tied to a relatively prolonged final lean-burn stage (that develops at the reacting mixing interface after gasification chamber 10 is shut close) assures full oxidation of diverse hydrocarbon species. Accordingly, formation of PM, NMOG and HCHO is minimized when compared to prior art ICEs.

The above described combustion process is qualitative only. A quantitative evaluation requires a state-of-the-art computational modeling and simulation for each particular engine-fuel combination. Two separate modeling are required, (1) the vaporization/gasification process inside gasification chamber 10 while accounting for heat losses into gasification chamber 10 and cylinder 20 walls as well as heat transferred into fuel droplets, fuel distillation, chemical breakdown and (2) accurate mixing and chemistry formulation to account from the initial rich-burn thru the final lean-burn stages including heat losses into engine walls. Ultimately experimental measurements are indispensable to fine tune a prototype.

Summarizing, disclosed F-C-M & C-C when applied to ICEs offers: (1) substantial abatement of raw exhaust contaminants affected by emission standards regulation and (2) improved fuel economy when compared to SI, CI and HCCI type engines.

Gasification chamber inlet 34, see FIG. 1 and FIG. 2, is pressure sealed by a pair of piston rings, top piston ring 38 and middle piston ring 40, to prevent leakage from or into gasification chamber 10. In order to minimize leaks, intake port 42 and exhaust port 44 are placed away from the sweeping trajectory 46 traveled by gasification chamber inlet 34 over the wall of cylinder 20, see Section B-B on FIG. 2. In this case, any minute leak is ingested by intake stream 30s thus, no fuel is wasted or exhaust is contaminated.

Starting the ICE depicted by FIG. 1 and FIG. 2 requires a special procedure. For example, fuel injector 24 can be briefly pre-heated by electric means so that fuel spray 32 is injected pre-heated. This facilitates a cold starting permitting sufficient number of transition combustion cycles until a self sustaining F-C-M & C-C process is realized. Alternatively, an appropriate fuel can be sprayed into either intake stream 30 or combustion chamber 22 to attain CI or SI combustion until a self sustaining F-C-M & C-C process is realized.

The ICE depicted by FIG. 1 and FIG. 2 represents a simple embodiment of this invention suitable to efficiently operation within a relatively narrow band of load and speed. Automobile engines and many other ICEs run within a very wide range of load and speed requiring adjustable timing of its combustion initiation to meet regulated emission criteria and/or optimize fuel economy.

Notice that the distance “D” between the bottom edge 36 of transfer port 18 and the TDC determines combustion timing. Nevertheless, factors such as transfer port 18 geometrical dimension, direction of flow direction arrow 26 and initial magnitude of the pressure differential prevailing between combustion chamber 22 and gasification chamber 10 also affect effective combustion initiation timing. As engine speed increases combustion initiation timing needs to occur earlier and vice versa.

FIG. 4 shows a 2-stroke engine analogous to the one shown in FIG. 1 and FIG. 2 except that piston 12 incorporates a pair of gasification chambers 10-10 and a corresponding pair of transfer ports 18-18. Notice that the distance between the bottom edges 36-36 of transfer ports 18-18 and the TDC are different. Distance “D₁” is larger than distance “D₂”. During engine running at high speed fuel is injected mainly into gasification chamber 10 facing distance “D₁” while at low speed and idle fuel is injected mainly into the gasification chamber 10 facing distance “D₂”. During part load operation the fuel can be simultaneously injected into both gasification chambers 10-10. By properly splitting the amount of fuel injected into each gasification chambers 10-10 a sort of stratified combustion would take place inside combustion chamber 22 permitting to optimize combustion efficiency.

A multiplicity of gasification chambers 10s could be incorporated into piston 12 each with matching transfer ports 18 of different distance between their bottom edges 36s and the TDC. This approach could be desirable in order to optimize the overall combustion process within a wide range of load and speed.

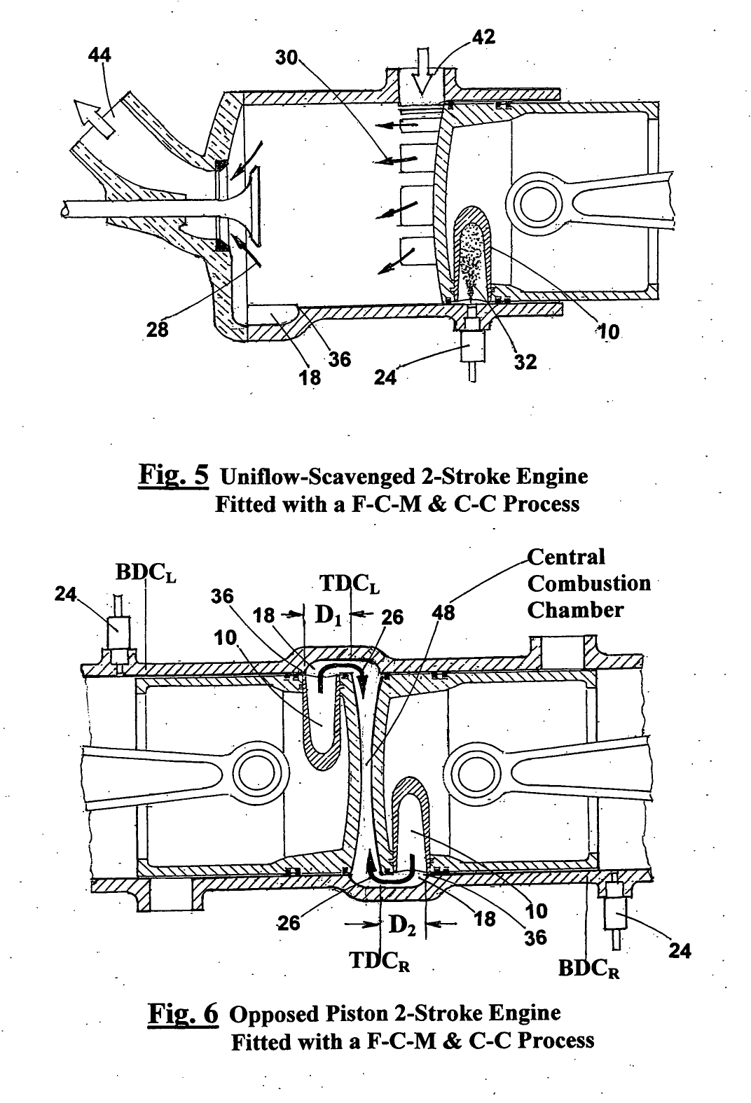

The reader will realize that application of the F-C-M & C-C process is also suitable for incorporation into a uniflow scavenged 2-stroke engine as shown in FIG. 5. The process into this engine operates by the same manner described above.

Notice that a fixed geometry transfer port 18 is not suitable for application into a 4-strokes engine since during the end of the exhaust stroke and the beginning of the intake stroke the combustion products entrapped into gasification chamber 10 will transfer into combustion chamber 22 defeating the object of the invention. Nevertheless, this obstacle could be circumvented by adding a cyclical shutoff mechanism onto transfer port 18.

### DESCRIPTION OF ADDITIONAL EMBODIMENTS

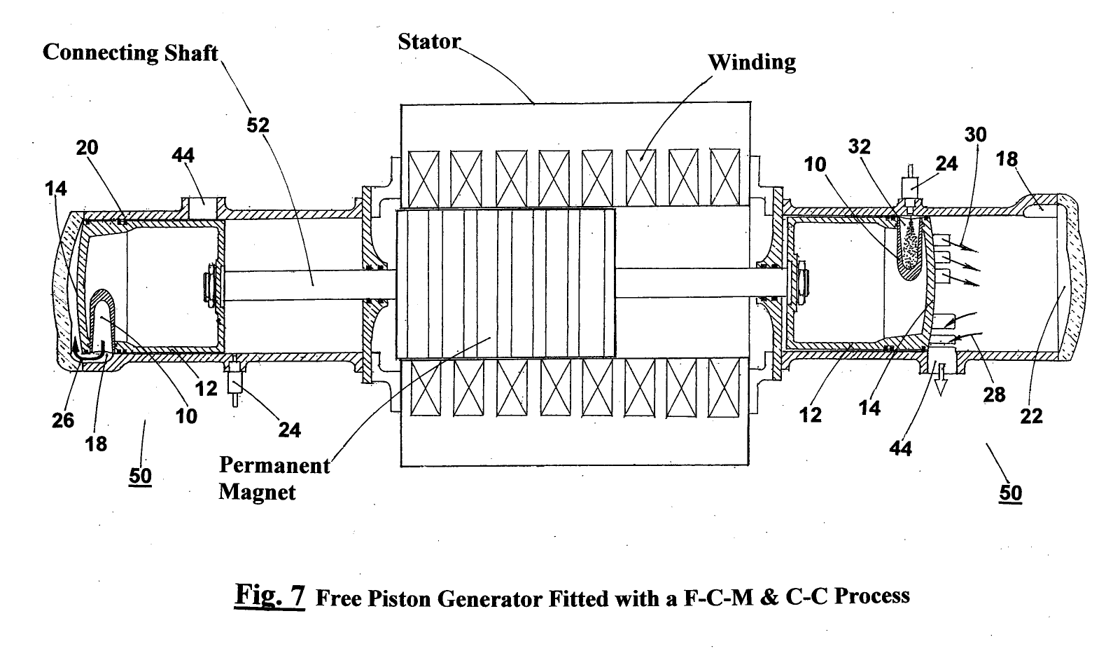

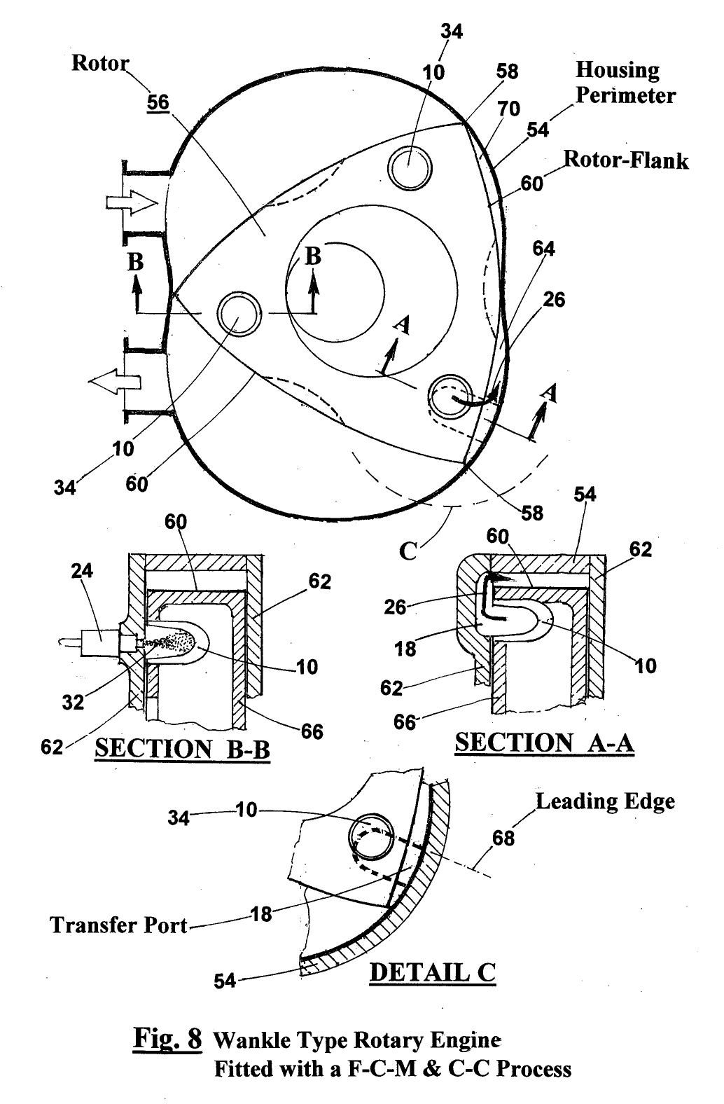

Referring specifically to the entirety of this invention, another preferred embodiment is shown in FIG. 6 that depicts in longitudinal cross-section a portion of an opposed piston engine illustrated in accordance with the objectives of this invention by incorporating a F-C-M & C-C process comprising: a pair of gasification chambers 10-10 one affixed into each pair of pistons 12-12 (each being placed under respective piston crowns 14 and above wrist pins 16), a pair of transfer ports 18-18 carved into the wall of cylinder 20 around the TDC_{L} and the TDC_{R} each connects into central combustion chamber 48 and a pair of fuel injectors 24-24 located on the wall of cylinder 20 bellow the pair of BDC_{L} and BDC_{R}. The pair of flow direction arrows 26-26 indicates that thermally conditioned fuel is being transferred from gasification chambers 10-10 into central combustion chamber 48. For simplicity in FIG. 7 the pair of crankshafts that synchronize pistons 12-12 displacement are not shown.

In operation, referring to FIG. 6, notice that both flow direction arrows 26-26 indicate that the thermally conditioned fuel prevailing inside gasification chambers 10-10 is transferred into central combustion chamber 48 initiating combustion with the hot-compressed air filling said central combustion chamber 48. As both pistons 12-12 travel toward their respective TDCs, namely the TDC_{L} and the TDC_{R}, this process is initiated when gasification chamber inlets 34-34 meet the bottom edge 36 of transfer ports 18-18. During the downward movement of pistons 12-12 as combustion has almost being completed the pressure level prevailing inside central combustion chamber 48 is higher than that inside gasification chambers 10-10 causing a back flow that fills gasification chambers 10-10 with hot combustion gases.

The remainder of the cycle is identical to the above description related to FIG. 1, FIG. 2, FIG. 4 and FIG. 5. The inclusion of multiple gasification chambers 10 into each piston 12 with each corresponding transfer ports 18 sized for different distances “D₁” and “D₂” may prove beneficial for combustion timing control.

Another preferred embodiment is shown in FIG. 7 that depicts in longitudinal cross-section a free piston engine driving a linear electrical alternator. The engine depicted in FIG. 7 is illustrated in accordance with the objectives of this invention by incorporating the F-C-M & C-C process. The engine comprises: a pair of 2-stroke power modules 50-50 interconnected by a push-pull connecting shaft 52. Each power modules 50 comprises: a gasification chamber 10 affixed into piston 12 being placed under piston crowns 14, a transfer port 18 carved into the wall of cylinder 20 around the TDC connects into combustion chamber 22 and a fuel injectors 24 located on the wall of cylinder 20 bellow the BDC. Flow direction arrow 26 indicates that thermally conditioned fuel is being transferred from gasification chamber 10 into combustion chamber 22. Notice that during the down stroke of piston 12 gasification chamber 10 must always face fuel injectors 24 to permit fuel injection. Consequently, means (not shown in FIG. 7) to prevent rotation of piston 12 inside cylinder 20 is required.

Operation of each power module 50 is identical to that of the 2-stroke engine described by FIG. 1 and FIG. 2, therefore all the teaching presented there is also applicable to this free-piston engine.

In the prior art there are different design arrangements and applications of the free piston engine concept. Nevertheless, incorporation of a F-C-M & C-C process is directly applicable into all of those free piston engines.

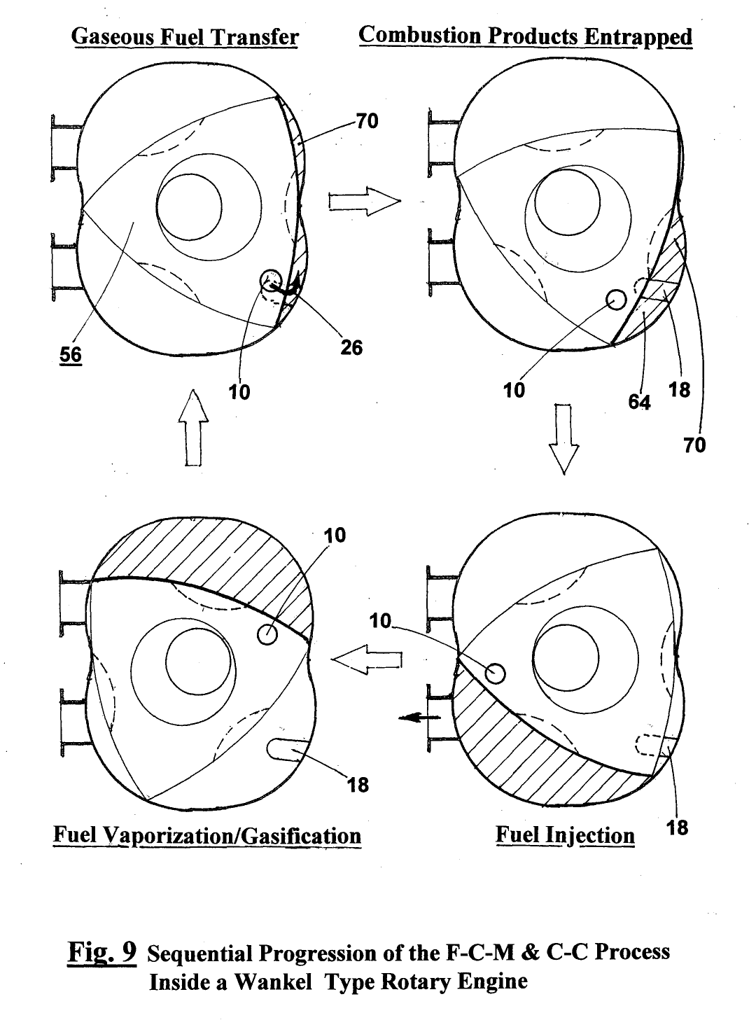

Another preferred embodiment is shown in FIG. 8 and FIG. 9 depicting in various cross-sections a Wankel type rotary engine illustrated in accordance with the objectives of this invention by incorporating a F-C-M & C-C process. The Wankel type rotary engine comprises: a housing perimeter 54, three gasification chambers 10-10-10 affixed into a rotor 56 each being placed near one of the three rotor apexes 58-58-58 under the three rotor-flanks 60-60-60, a transfer port 18 carved into housing-side wall 62 is positioned within the moving combustion chamber 64 and a fuel injectors 24 located on said housing-side wall 62. Each of the three gasification chambers 10-10-10 comprise a gasification chamber inlet 34 located on the same rotor-side wall 66.

For easy visualization of the 4-strokes cycle that evolves inside the Wankel type rotary engine and to understand the accomplishment of the F-C-P & AC process, FIG. 9 illustrates four different positions of rotor 56 during a rotor revolution. To facilitate visual analysis only a single gasification chamber 10 is shown affixed to the three-sided symmetric rotor 56 and in addition the corresponding variable volume is crosshatched. The labeling associated to each position of rotor 56 makes FIG. 9 self-explanatory for those readers skilled in this art.

Location of transfer port 18 cannot be arbitrarily choose, see Section A-A and Detail C in FIG. 8, since it controls combustion initiation timing when gasification chamber inlet 34 reaches leading edge 68. Combustion process is identical to the one described above, therefore, for those readers skilled in this art there is no need for a repetitive explanation.

Notice that location of fuel injectors 24, see Section B-B in FIG. 8, assures that its tip is working on a relatively cold environ since it is never exposed to combustion products. The location of fuel injectors 24 can be changed without altering the accomplishment of the F-C-M & C-C process as long as it is capable of injecting fuel into gasification chamber 10.

It is important to realize that the volume of squeezed gas 70 located near the trailing end of rotor-flank 60, near one apex 56, is air reach thus the exhaust is not burden with unburned fuel and CO as tends to occur with prior art Wankel type rotary engines. Inside those prior art engines the relatively elongated squeezed gas 70 volume prevents the flame front from reaching the trailing edge of moving combustion chamber 64.

Still another preferred embodiment is shown in FIG. 10 that incorporates two gasification chambers 10-10 affixed into opposed rotor-side walls 66s under the same rotor-flank 60 (see Section D-D in FIG. 10) requiring that their corresponding transfer ports 18-18 be located on opposed housing-side walls 62-62 and that fuel injectors 24-24 (see Section E-E in FIG. 10) also be located on opposed housing-side walls 62-62. Notice that the individual location of leading edges 68-68 (part of each transfer port 18) could be peripherally different (see Detail F in FIG. 10) that shows a peripheral distance “P”. This peripheral spacing allows the control of combustion initiation timing under different engine load and speed.

During engine running at high speed fuel is injected mainly into gasification chamber 10 whose gasification chamber inlet 34 first reaches a leading edge 68, while at low speed and idle fuel is injected mainly into the other gasification chamber 10, the one whose gasification chamber inlet 34 last reaches a leading edge 68. During part load operation the fuel could be simultaneously injected into both gasification chambers 10-10.

Given the above descriptions, the reader can appreciate the non-obvious novelty disclosed.

### SUMMARY AND SCOPE OF INVENTION

A strenuous effort is taking place worldwide to conceive and develop improved ICEs. Decades of ongoing research and development, testing and refinement has yielded impressive improvement in tailpipe exhaust cleaning by use of intricate micro-computer controlled fuel management, sophisticated combustion chamber designs, special fuel formulation and adequate fuel additives as well as a variety of complex and costly devices for after-treatment of raw exhaust.

The herein disclosed F-C-M & C-C process allows to minimize raw exhaust contaminants from ICEs when compared to actual prior art levels. Raw emissions could be low enough to eliminate the need for tail pipe after-treatment systems. In addition, application of this invention yields better fuel economy.

Accordingly, the reader will see that the F-C-M & C-C process disclosed provides manufacturers of specific engines applicable to automobiles, trucks, small airplanes, small helicopters, military vehicles, power plants, marine propulsion, rail locomotives, mine's clean energy sources, etceteras with new, safe, reliable, useful and less costly strategic means that will permit (1) to substantially abate air pollution contamination, (2) to improved fuel economy and (3) to allow utilization of diverse liquid fuels when comparing to prior art engines.

One or more embodiments of this invention may offer one or more of the following advantages when compared to prior art engines:
Combustion of hot gaseous-phase-fuel species derived from a supplied liquid fuel source.
An initial rich-burn mode minimizes NO_{X} formation.
A final lean-burn stage minimizes unburned hydrocarbons, CO and PM contaminants.
No fuel is wasted into exhaust improving fuel economy.
The distinctive fast oxidation reaction rates improve thermodynamic cycle efficiency that also improves fuel economy.
The mixing controlled combustion zone precludes detonation therefore it is not required to use fuel with octane number rating.
The combustion develops with negligible ignition delay consequently it is not required to use fuel with cetane number rating.
A less costly and more rugged fuel injection system is suitable.
Mechanical reliability is preserved because no valves or driving mechanisms are added to the basic engine.

The above description contains many specificities; these should not be construed as limiting the scope of the invention, but rather as merely providing illustrations of some of the presently envisioned embodiments of this invention. Any replacement of parts that are functionally equivalent is within the scope of this invention. Indeed, from the foregoing description, various other variations and changes will become apparent to those skilled in the art without departing from the spirit and scope of this invention.

The reader will find that the embodiments illustrated by FIG. 1, FIG. 2, and FIG. 5 and various other equivalent variations and changes derived are covered by claims 1 through 3. The embodiment illustrated by FIG. 4 and various other equivalent variations and changes derived are covered by claims 4 through 6. The embodiment illustrated by FIG. 6 and various other equivalent variations and changes derived are cover by claims 7 through 15. The embodiment illustrated by FIG. 7 and various other equivalent variations and changes derived are covered by claim 16 and claim 17. The embodiment illustrated by FIG. 8 and various other equivalent variations and changes are covered by claim 18. The embodiment illustrated by FIG. 10 and various other equivalent variations and changes are covered by claim 19.

The scope of this invention should be determined by the appended claims and their legal equivalents, rather than by the embodiments illustrated.

I claim:

1. Incorporation of a fuel-conditioning-method and coupled-combustion process into a 2-stroke piston engine that allows to minimize raw exhaust emission contaminants and to improve fuel economy when compared to prior art 2-stroke piston engines, the improvement comprising:
(a) a gasification chamber affixed into a piston of said piston engine placed under said piston crown; itself comprising a gasification chamber inlet, and
(b) a transfer port carved into a cylinder wall of said piston engine; itself connecting into a combustion chamber of said piston engine, and
(c) a fuel injector placed on said cylinder wall bellow said transfer port
whereby as combustion develops inside said combustion chamber combustion products transfer into said gasification chamber by passing across said transfer port and said gasification chamber inlet until the down stroke of said piston causes said gasification chamber inlet to become sealed by said cylinder wall entrapping said combustion products inside said gasification chamber subsequently said fuel injector sprays a metered amount of liquid fuel into said gasification chamber causing the sprayed liquid fuel to transform into a vaporized or gasified fuel while said piston continues with an upstroke until when said gasification chamber inlet reaches said transfer port thereby connecting said gasification chamber and said combustion chamber allowing said vaporized or gasified fuel passing across said gasification chamber inlet and said transfer port thus injecting said vaporized or gasified fuel into said combustion chamber filled with air causing combustion to develop initiating an anew cycle of said piston engine.

2. The incorporation of a fuel-conditioning-method and coupled-combustion process of claim 1 wherein said gasification chamber inlet is placed between a pair of piston rings of said piston whereby improving the sealing of said gasification chamber against said cylinder wall thereby minimizing seepage of said entrapped combustion products and said vaporized or gasified fuel.

3. The incorporation of a fuel-conditioning-method and coupled-combustion process of claim 2 wherein said fuel injector is placed under the bottom dead ce of said cylinder wall whereby permitting said fuel injector to work in a relatively cold environ.

4. Incorporation of a fuel-conditioning-method and coupled-combustion process into a 2-stroke piston engine that allows to minimize raw exhaust emission contaminants and to improve fuel economy when compared to prior art 2-stroke piston engines, the improvement comprising:
(a) a multiplicity of gasification chambers affixed into a piston of said piston engine placed under said piston crown; each individual gasification chamber from said multiplicity of gasification chambers comprising a gasification chamber inlet, and
(b) a multiplicity of transfer ports carved into a cylinder wall of said piston engine; each individual transfer port from said multiplicity of transfer ports connecting into a combustion chamber of said piston engine, and
(c) a multiplicity of fuel injectors placed on said cylinder wall bellow said multiplicity of transfer ports
whereby as combustion develops inside said combustion chamber combustion products transfer into said multiplicity of gasification chambers by passing across said multiplicity of transfer ports and said multiplicity of gasification chamber inlets until a down stroke of said piston causes said multiplicity of gasification chamber inlets to become sealed by said cylinder wall entrapping said combustion products inside said multiplicity of gasification chambers subsequently said multiplicity of fuel injectors spray a metered amount of liquid fuel into said multiplicity of gasification chambers causing the sprayed liquid fuel to transform into a vaporized or gasified fuel while said piston continues with an upstroke until when said multiplicity of gasification chamber inlets reach said multiplicity of transfer ports thereby connecting said multiplicity of gasification chambers and said combustion chamber allowing said vaporized or gasified fuel passing across said multiplicity of gasification chamber inlets and said multiplicity of transfer ports thus injecting said vaporized fuel into said combustion chamber filled with air causing combustion to develop initiating an anew cycle of said piston engine.

5. The incorporation of a fuel-conditioning-method and coupled-combustion process of claim 4 wherein said multiplicity of gasification chamber inlets are placed between a pair of piston rings of said piston whereby improving the sealing of said multiplicity of gasification chambers against said cylinder wall thereby minimizing seepage of said entrapped combustion products and vaporized or gasified fuel.

6. The incorporation of a fuel-conditioning-method and coupled-combustion process of claim 5 wherein said multiplicity of, fuel injectors are placed under the bottom dead center of said cylinder wall whereby permitting said multiplicity of fuel injector to work in a relatively cold environ.

7. Incorporation of a fuel-conditioning-method and coupled-combustion process into an opposed piston engine that allows to minimize raw exhaust emission contaminants and to improve fuel economy when compared to prior art opposed piston engines, the improvement comprising:
(a) a gasification chambers affixed into a piston of said opposed piston engine placed under said piston crown; said gasification chamber comprising a gasification chamber inlet, and
(b) a transfer ports carved into a cylinder wall of said opposed piston engine; said transfer port connecting into a central combustion chamber of said opposed piston engine, and
(c) a fuel injector placed on said cylinder wall bellow said transfer port
whereby as combustion develops inside said central combustion chamber combustion products transfer into said gasification chamber by passing across said transfer port and said gasification chamber inlet until a down stroke of said piston causes said gasification chamber inlet to become sealed by said cylinder wall entrapping said combustion products inside said gasification chamber subsequently said fuel injector sprays a metered amount of liquid fuel into said gasification chamber causing the sprayed liquid fuel to transform into a vaporized or gasified fuel while said piston continue with an upstroke until when said gasification chamber inlet reaches said transfer port thereby connecting said gasification chamber and said central combustion chamber allowing said vaporized or gasified fuel passing across said gasification chamber inlet and said transfer port thus injecting vaporized or gasified fuel into said central combustion chamber filled with air causing combustion to develop initiating an anew cycle of said opposed piston engine.

8. The incorporation of a fuel-conditioning-method and coupled-combustion process of claim 7 wherein said gasification chamber inlets is placed between a pair of piston rings of said piston whereby improving the sealing of said gasification chamber against said cylinder wall thereby minimizing seepage of said entrapped combustion products and said vaporized or gasified fuel.

9. The incorporation of a fuel-conditioning-method and coupled-combustion process of claim 8 wherein said fuel injector is placed under the bottom dead center of said cylinder wall whereby permitting said fuel injector to work in a relatively cold environ.

10. Incorporation of a fuel-conditioning-method and coupled-combustion process into an opposed piston engine that allows to minimize raw exhaust emission contaminants and to improve fuel economy when compared to prior art opposed piston engines, the improvement comprising:
(a) two gasification chambers each affixed into a piston of said opposed piston engine placed under each of said piston crown; each gasification chamber comprising a gasification chamber inlet, and
(b) two transfer ports carved into a cylinder wall of said opposed piston engine; each transfer port connecting into a central combustion chamber of said opposed piston engine, and
(c) two fuel injectors placed on said cylinder wall bellow each of said transfer ports
whereby as combustion develops inside said central combustion chamber combustion products transfer into each of said gasification chambers by passing across each of said transfer ports and each of said gasification chamber inlets until a down stroke of each of said pistons causes each of said gasification chamber inlets to become sealed by said cylinder wall entrapping said combustion products inside each of said gasification chambers subsequently each of said fuel injectors sprays a metered amount of liquid fuel into one of each of said gasification chambers causing the sprayed liquid fuel to transform into a vaporized or gasified fuel while each of said pistons continue with a upstroke until when each of said gasification chamber inlets reach each of said transfer ports thereby connecting each of said gasification chambers and said central combustion chamber allowing said vaporized or gasified fuel passing across each of said gasification chamber inlets and said transfer ports thus injecting vaporized or gasified fuel into said central combustion chamber filled with air causing combustion to develop initiating an anew cycle of said opposed piston engine.

11. The incorporation of a fuel-conditioning-method and coupled-combustion process of claim 10 wherein said two gasification chamber inlets are placed between a pair of piston rings of said pistons whereby improving the sealing of said two gasification chambers against said cylinder wall thereby minimizing seepage of said entrapped combustion products and said vaporized or gasified fuel.

12. The incorporation of a fuel-conditioning-method and coupled-combustion process of claim 11 wherein said two fuel injectors are placed under the bottom dead center of said cylinder wall whereby permitting said multiplicity of fuel injector to work in a relatively cold environ.

13. Incorporation of a fuel-conditioning-method and coupled-combustion process into an opposed piston engine that allows to minimize raw exhaust emission contaminants and to improve fuel economy when compared to prior art opposed piston engines, the improvement comprising:
(a) a multiplicity of gasification chambers affixed into each piston of said opposed piston engine placed under each of said piston crown; each gasification chamber comprising a gasification chamber inlet, and
(b) a multiplicity of transfer ports carved into a cylinder wall of said opposed piston engine; each transfer port connecting into a central combustion chamber of said opposed piston engine, and
(c) a multiplicity of fuel injectors placed on said cylinder wall bellow each of said multiplicity of transfer ports
whereby as combustion develops inside said central combustion chamber combustion products transfer into each of said multiplicity of gasification chambers by passing across each of said multiplicity of transfer ports and each of said gasification chamber inlets until a down stroke of each of said pistons causes each of said gasification chamber inlets to become sealed by said cylinder wall entrapping said combustion products inside each of said multiplicity of gasification chambers subsequently each of said multiplicity of fuel injectors sprays a metered amount of liquid fuel into each of said multiplicity of gasification chambers causing the sprayed liquid fuel to transform into a vaporized o gasified fuel while each of said pistons continue with an upstroke until when each of said gasification chamber inlets reaches each of said multiplicity of transfer ports thereby connecting each of said gasification chambers and said central combustion chamber allowing said vaporized or gasified fuel passing across each of said multiplicity of gasification chambers inlets and said multiplicity of transfer ports thus injecting vaporized fuel into said central combustion chamber filled with air causing combustion to develop initiating an anew cycle of said opposed piston engine.

14. The incorporation of a fuel-conditioning-method and coupled-combustion process of claim 13 wherein said multiplicity of gasification chamber inlets are placed between a pair of piston rings of said pistons whereby improving the sealing of said multiplicity of gasification chambers against said cylinder wall thereby minimizing seepage of the entrapped combustion products and vaporized or gasified fuel.

15. The incorporation of a fuel-conditioning-method and coupled-combustion process of claim 14 wherein said multiplicity of fuel injectors are placed under the bottom dead center of said cylinder wall whereby permitting said multiplicity of fuel injector to work in a relatively cold environ.

16. Incorporation of a fuel-conditioning-method and coupled-combustion process into each of the two power modules of a free piston electric generator engine that allows to minimize raw exhaust emission contaminants and to improve fuel economy when compared to prior art free piston electric generator engines, the improvement comprising:
(a) a gasification chamber affixed into each piston of said two power modules placed under said piston crown; itself comprising a gasification chamber inlet, and
(b) a transfer port carved into each cylinder wall of said two power modules; itself connecting into a combustion chamber of said two power modules, and
(c) a fuel injector placed on each cylinder wall of said two power modules bellow each of said transfer ports
whereby as combustion develops inside said combustion chamber of said two power modules combustion products transfer into each of said gasification chambers by passing across each of said transfer ports and each of said gasification chamber inlets until a down stroke of each of said pistons causes each of said gasification chamber inlets to become sealed by said cylinder wall entrapping said combustion products inside each of said two gasification chambers subsequently each of said fuel injectors sprays a metered amount of liquid fuel into each of said gasification chambers causing the sprayed liquid fuel to transform into a vaporized or gasified fuel while each of said pistons continue with an upstroke until when each of said gasification chamber inlets reaches each of said transfer ports thereby connecting each of said gasification chambers and said combustion chamber of said two power modules allowing said vaporized or gasified fuel passing across each of said gasification chamber inlets and of said transfer ports thus injecting vaporized or gasified fuel into said central combustion chamber filled with air causing combustion to develop initiating an anew cycle of said two power modules.

17. Incorporation of a fuel-conditioning-method and coupled-combustion process into each of the two power modules of a free piston electric generator engine that allows to minimize raw exhaust emission contaminants and to improve fuel economy when compared to prior art free piston electric generator engines, the improvement comprising:
(a) a multiplicity of gasification chambers affixed into each piston of said two power modules placed under said piston crown; each gasification chamber comprising a gasification chamber inlet, and
(b) a multiplicity of transfer ports carved into each cylinder wall of said two power modules; themselves connecting into a combustion chamber of said two power modules, and
(c) a multiplicity of fuel injectors placed on each cylinder wall of said two power modules bellow each of said multiplicity of transfer ports
whereby as combustion develops inside said combustion chamber of said two power modules combustion products transfer into each of said multiplicity of gasification chambers by passing across each of said multiplicity of transfer ports and each of said multiplicity of gasification chamber inlets until a down stroke of each of said pistons causes each of said multiplicity of gasification chamber inlets to become sealed by said cylinder wall entrapping said combustion products inside each of said multiplicity of gasification chambers subsequently each of said multiplicity of fuel injectors sprays a metered amount of liquid fuel into each of said multiplicity of gasification chambers causing the sprayed liquid fuel to transform into a vaporized or gasified fuel while each of said pistons continue with an upstroke until when each of said multiplicity of gasification chamber inlets reaches each of said multiplicity of transfer ports thereby connecting each of said multiplicity of gasification chambers and said combustion chamber of said two power modules allowing said vaporized or gasified fuel passing across each of said multiplicity of gasification chamber inlets and of said multiplicity of transfer ports thus injecting vaporized or gasified fuel into said combustion chamber of said two power modules filled with air causing combustion to develop initiating an anew cycle of said two power modules.

18. The incorporation of a fuel-conditioning-method and coupled-combustion process into a Wankel type rotary engine that allows to minimize raw exhaust emission contaminants and to improve fuel economy when compared to prior art Wankel type rotary engines, the improvement comprising:
(a) a gasification chamber affixed under each rotor-flank from the group of three rotor-flanks making the rotor of said Wankel type rotary engine; each of said gasification chamber comprising a gasification chamber inlet, and
(b) a transfer port carved into a housing-side wall of said Wankel type rotary engine placed within the area swept by a moving combustion chamber, and
(c) a fuel injector placed on said housing-side wall outside the area swept by said moving combustion chamber
whereby as combustion develops inside said moving combustion chamber combustion products transfer into said gasification chamber by passing across said transfer port and said gasification chamber inlet until the rotation of said rotor-flank causes said gasification chamber inlet to become sealed by said housing-side wall entrapping said combustion products inside said gasification chamber subsequently said fuel injector sprays a metered amount of liquid fuel into said gasification chamber causing the sprayed liquid fuel to transform into a vaporized or gasified fuel while said rotor-flank continues rotating until when said gasification chamber inlet reaches said transfer port thereby connecting said gasification chamber and said moving combustion chamber allowing the passing of said vaporized or gasified fuel across said gasification chamber inlet and said transfer port injecting said vaporized or gasified fuel into said moving combustion chamber filled with air causing combustion to develop initiating an anew cycle above said rotor-flank of said Wankel type rotary engine, a cycle that consecutively and independently repeats for each of the other two rotor-flanks.

19. Incorporation of a fuel-conditioning-method and coupled-combustion process into a Wankel type rotary engine that allows to minimize raw exhaust emission contaminants and to improve fuel economy when compared to prior art Wankel type rotary engines, the improvement comprising:
(a) two gasification chambers affixed under each rotor-flank from the group of three rotor-flanks making the rotor of said Wankel type rotary engine; each of said gasification chamber comprising a gasification chamber inlet, and
(b) two transfer ports each carved into one of the two housing-side walls of said Wankel type rotary engine placed within the area swept by a moving combustion chamber, and
(c) two fuel injectors each placed on one of the two housing-side walls outside the area swept by said moving combustion chamber
whereby as combustion develops inside said moving combustion chamber combustion products transfer into said two gasification chambers by passing across said two transfer ports and said gasification chamber inlets until the rotation of said rotor-flank causes said two gasification chamber inlets to become sealed by both of said housing-side walls entrapping said combustion products inside said two gasification chambers subsequently said fuel injector sprays a metered amount of liquid fuel into said two gasification chambers causing the sprayed liquid fuel to transform into a vaporized or gasified fuel while said rotor-flank continues rotating until when said two gasification chamber inlets reach said two transfer ports thereby connecting said two gasification chambers and said moving combustion chamber allowing the passing of said vaporized o gasified fuel across said two gasification chamber inlets and said two transfer ports injecting said vaporized or gasified fuel into said moving combustion chamber filled with air causing combustion to develop initiating an anew cycle above said rotor-flank of said Wankel type rotary engine, a cycle that consecutively and independently repeats for each of the other two rotor-flanks.

20. Incorporation of a fuel-conditioning-method and coupled-combustion process into a Wankel type rotary engine that allows to minimize raw exhaust emission contaminants and to improve fuel economy when compared to prior art Wankel type rotary engines, the improvement comprising:
(a) a multiplicity of gasification chambers affixed under each rotor-flank from the group of three rotor-flanks making the rotor of said Wankel type rotary engine; each of said gasification chamber comprising a gasification chamber inlet, and
(b) a multiplicity of transfer ports each carved into one of the two housing-side walls of said Wankel type rotary engine placed within the area swept by a moving combustion chamber, and
(c) a multiplicity of fuel injectors each placed on one of the two housing-side walls outside the area swept by said moving combustion chamber
whereby as combustion develops inside said moving combustion chamber combustion products transfer into said multiplicity of gasification chambers by passing across said multiplicity of transfer ports and said multiplicity of gasification chamber inlets until the rotation of said rotor-flank causes said multiplicity of gasification chamber inlets to become sealed by both of said housing-side walls entrapping said combustion products inside said multiplicity of gasification chambers subsequently said multiplicity of fuel injectors sprays a metered amount of liquid fuel into said multiplicity of gasification chambers causing the sprayed liquid fuel to transform into a vaporized or gasified fuel while said rotor-flank continues rotating until when said multiplicity of gasification chamber inlets reach said multiplicity of transfer ports thereby connecting said multiplicity of gasification chambers and said moving combustion chamber allowing the passing of said vaporized o gasified fuel across said multiplicity of gasification chamber inlets and said multiplicity of transfer ports injecting said vaporized or gasified fuel into said moving combustion chamber filled with air causing combustion to develop initiating an anew cycle above said rotor-flank of said Wankel type rotary engine, a cycle that consecutively and independently repeats for each of the other two rotor-flanks.
